(19) United States
(12) Patent Application Publication
(10) Pub. No.: US 2026/0194099 A1
(43) Pub. Date: Jul. 9, 2026

(54) MOUNTING SYSTEM FOR VEHICULAR COMPONENTS

(71) Applicant: JOHNSON ELECTRIC INTERNATIONAL AG, Murten (CH)

(72) Inventors: Emmanuel VUICHARD, Epagny (CH); Adrien AYMON, Murten (CH); Jonas ARDIOLI, Pleigne (CH)

(21) Appl. No.: 19/557,383

(22) Filed: Mar. 5, 2026

Related U.S. Application Data
(63) Continuation of application No. PCT/EP2023/076665, filed on Sep. 27, 2023.

(51) Int. Cl. F16B 21/02

(52) U.S. Cl. CPC F16B 21/02

(57) ABSTRACT

A mounting system for vehicular components is provided. There is a male connector having a spigot and a plurality of radial tabs extending from the spigot and a female connector having a primary receiver for receiving the spigot of the male connector and a plurality of secondary receivers for receiving the plurality of radial tabs in a twist-lock arrangement. The male connector and the female connector are integrally formed with or associated with a first vehicular component and a second vehicular component to permit interconnection of the first and second vehicular components via the mounting system. There is also a vibration damping member receivable around the spigot so as to be in abutment engagement with the female connector when connected to the male connector and provide vibrational damping therebetween.

### CROSS REFERENCE TO RELATED APPLICATIONS

This non-provisional patent application is a continuation application of PCT Application No. PCT/EP2023/076665, filed with the European Patent Office on September 27, 2023, all of which are incorporated herein by reference in their entirety.

### FIELD OF THE INVENTION

The present invention relates to a mounting system for vehicular components, and more particularly to a mounting system with at least one integrally formed connector. The present invention further relates to a vehicular component assembly and to a vehicular component with an integrally formed connector.

### BACKGROUND

The mounting of vehicular components typically accomplished by way of a mounting bracket and screws. To prevent damage to and maintain correct alignment of sensitive vehicular components, such as but not limited to valves, pumps, and fans, the mounting system must be robust to the vibrations encountered during vehicle operation. Typically, separate shock absorbers are included in a mounting system for this purpose.

The large number of components in such a mounting system leads to an increase in manufacturing cost and difficulty, and increases the complexity of supply chain and inventory management at the sites where vehicles are manufactured and/or repaired.

### SUMMARY OF THE INVENTION

The object of the present invention is therefore to provide a mounting system for vehicular components which obviates or overcomes the above-mentioned deficiencies.

According to a first aspect of the invention, there is provided a mounting system for vehicular components, the mounting system comprising: a male connector having a spigot and a plurality of radial tabs extending from the spigot; a female connector having a primary receiver for receiving the spigot of the male connector and a plurality of secondary receivers for receiving the plurality of radial tabs in a twist-lock arrangement; and characterised in that the male connector or the female connector is integrally formed with a module housing of a first vehicular component, and the other of the male connector and female connector is associated with a second vehicular component to permit interconnection of the first and second vehicular components via the mounting system, and further comprising a vibration damping member receivable around the spigot so as to be in abutment engagement with the female connector when connected to the male connector and provide vibrational damping therebetween.

Such a mounting system for vehicular components provides several advantages over conventional vehicular component mounting systems. The integration of the male and/or female connector with vehicular components reduces the number of components needed, simplifying manufacturing and the logistics of supply chain and inventory management. Additionally, the mounting process is simplified due to the fewer components and fewer steps required for mounting, and can be quickly accomplished by hand without the use of tools. Furthermore, such a mounting system is robust to the vibrations encountered during the operation of a vehicle due to the provided vibrational damping.

Preferably, the male connector may be integrally formed with the said module housing of the said first vehicular component.

Having the male connector being integrally formed with the module housing of the first vehicular component allows for quicker and easier mounting of vehicular components, as the male connector does not have to be separately attached to the first vehicular component as a step in the mounting process. Additionally, reducing the number of parts of the mounting system reduces the complexity of manufacturing and simplifies inventory management and transportation of parts.

Optionally, the female connector may be provided as an adapter receivably engagable with the said second vehicular component.

The female connector being provided as an adapter receivably engagable with the second vehicular component allows for the female connector to be retrofit to existing vehicular components.

Preferably, the female connector may be integrally formed with a module housing of the second vehicular component.

The female connector being integrally formed with a module housing of the second vehicular component reduces the number of components required for the mounting process, simplifying the mounting process, and improving the logistics of manufacturing, supplying, and inventory management of components of the mounting system. The mounting process is additionally simplified, as the female connector does not have to be attached to a second vehicular component as a step in the mounting process.

Optionally, the female connector may comprise a connector body defining an internal chamber into which a head of the male connector is receivable.

The female connector having a connector body defining an internal chamber can provide improved engagement of the male connector with the female connector in a locked position by inhibiting the axial movement of the male connector relative to the female connector in a module-distal direction, making disengagement less likely.

Preferably, each of the plurality of radial tabs may have a module-facing surface engagable with the respective plurality of secondary receivers of the female connector.

The radial tabs of the mounting system each having a module-facing surface engageable with the secondary receivers of the female connector allows for the mounting system to be tightly locked, with contact between the radial tabs and the secondary receivers inhibiting rotational motion of the male connector relative to the female connector.

Preferably, the module-facing surfaces may have a tapered or angled cross-section.

A tapered or angled cross section of the module-facing surfaces provides a large contact area between the radial tabs and secondary receivers, better distributing wear and ensuring suitable engagement.

In one preferable embodiment, the plurality of secondary receivers may each have complementary shapes to the module-facing surfaces.

The secondary receivers being complementary to the module-facing surfaces provides better engagement of the radial tabs with the secondary receivers, preventing undesired disengagement of the radial tabs from the secondary receivers and ensuring a tight fit between the male connector and female connector, inhibiting rotational movement of the male connector relative to the female connector when in a locked position.

Preferably, one of the plurality of radial tabs may have a different shape or size to the other of the plurality of radial tabs.

One of the radial tabs having a different shape or size than the other said radial tabs means that the male connector has no rotational symmetry. This means that the male connector can only be inserted through the primary receiver in one orientation, which acts as a poka-yoke mechanism to prevent mounting of the first vehicular component and second vehicular component when the first vehicular component is incorrectly orientated relative to the second vehicular component.

Optionally, the male connector may comprise a buttress portion at a module-proximal end of the spigot.

A buttress portion at a module-proximal end of the spigot provides support for the male connector, preventing the male connector from shearing off or otherwise being dislocated from the module housing of the first vehicular component when subject to vibrations from vehicle operation.

The male connector may comprise a vibration-damping-member guide element associated with the spigot for aligning the vibration damping member.

Such a vibration-damping-member guide element maximises the efficacy of the vibration damping member by ensuring correct alignment and position of the vibration damping member relative to the male connector and female connector for maximum vibrational damping.

Optionally, the vibration-damping-member guide element may comprise a retaining element engagable with the vibration damping member to inhibit axial displacement thereof relative to the male connector.

A retaining element included in the vibration-damping-member guide element allows the vibration damping member to be installed onto and retained by the male connector. This can be done in advance, simplifying the transportation of parts and installation.

Preferably, the vibration damping member may be formed as a spring.

Springs are simple to manufacture and provide good vibration isolation and damping. Additionally, a spring can be positioned so as to be compressed when the male connector is received through the primary receiver, imparting a force between the male connector and the female connector which pushes the radial tabs into the secondary receivers, facilitating locking.

In one preferable embodiment, the spring may be a wave spring.

Wave springs take up less axial space than traditional coiled springs for the same requirements, allowing for a more compact and symmetric mounting system.

The female connector may comprise an inter-tab stop in-use positioned between adjacent tabs of the plurality of radial tabs to inhibit an incorrect relative rotation between the male connector and the female connector.

An inter-tab stop included as part of the female connector acts as a poka-yoke mechanism, preventing a user from rotating the male connector relative to the female connector too far or in the wrong direction. This prevents user-error when mounting the first vehicular component to the second vehicular component when a particular orientation of the first vehicular component relative to the second vehicular component is required.

According to a second aspect of the invention, there is provided a vehicular component assembly comprising a first vehicular component and a second vehicular component to be mounted to one another as part of a vehicle, the first and second vehicular components being mounted to one another via a mounting system in accordance with the first aspect of the invention.

Such a vehicular component assembly is easy to manufacture and assemble and can be easily disengaged for replacement or repair. Additionally, such a vehicular component assembly is robust to the vibrations encountered during the operation of a vehicle due to the provided vibrational damping.

Optionally, the first vehicular component may be a valve module, a pump module, or a fan module.

Valve modules, pump modules, and fan modules are all components which are relatively sensitive to damage from vibrations and additionally need to be correctly aligned with other components to function effectively. This makes them excellent candidates for components to be mounting using the discussed vehicular assembly.

According to a third aspect of the invention, there is provided a vehicle comprising a vehicular component assembly in accordance with the second aspect of the invention.

A vehicle comprising said vehicular component assembly is quicker and easier to construct than a typical vehicle.

According to a fourth aspect of the invention, there is provided a vehicular component comprising: a module housing; and a male connector having a spigot and a plurality of radial tabs extending from the spigot, the male connector being suitable for twist-lock engagement with a female connector having a primary receiver for receiving the spigot of the male connector and a plurality of secondary receivers for receiving the plurality of radial tabs; and characterised in that the male connector is integrally formed with the module housing.

Such a vehicular component has advantages over typical vehicular components as separate components such as a bracket are not required for mounting to another vehicular component, simplifying the mounting process. Supply chain and inventory management are also made easier due to fewer components being required to achieve mounting.

The vehicular component may further comprise a vibration damping member receivable around the spigot so as to be in abutment engagement with the said female connector when connected to the male connector and provide vibrational damping therebetween.

A vibration damping member provides vibration damping between the vehicular components, which can prevent damage to or misalignment off sensitive components.

### BRIEF DESCRIPTION OF THE DRAWINGS

FIG. 1 shows an exploded isometric representation of a first embodiment of a mounting system for vehicular components in accordance with the first aspect of the invention;

FIG. 2 shows a side view of a male connector of a first vehicular component of the mounting system of FIG. 1;

FIG. 3 shows a side view of the mounting system of FIG. 1 in a non-exploded condition;

FIG. 4 shows an isometric representation of the male connector of FIG. 3;

FIG. 5 shows a plan view of a female connector of the mounting system of FIG. 2;

FIG. 6 shows a cross-section through line A-A of the female connector of FIG. 5;

FIG. 7 shows a plan view of the mounting system of FIG. 2;

FIG. 8 shows a cross-section through line B-B of the mounting system of FIG. 7;

FIG. 9 shows a plan view of the mounting system of FIG. 2;

FIG. 10 shows a cross-section through line D-D of the mounting system of FIG. 9;

FIG. 11 shows an enlarged view of the section C of the mounting system of FIG. 10; and

FIG. 12 shows a side view of a vehicular component assembly in accordance with the second aspect of the invention.

### DETAILED DESCRIPTION OF THE PREFERRED EMBODIMENTS

The present invention will be further described below based on the drawings and the embodiments.

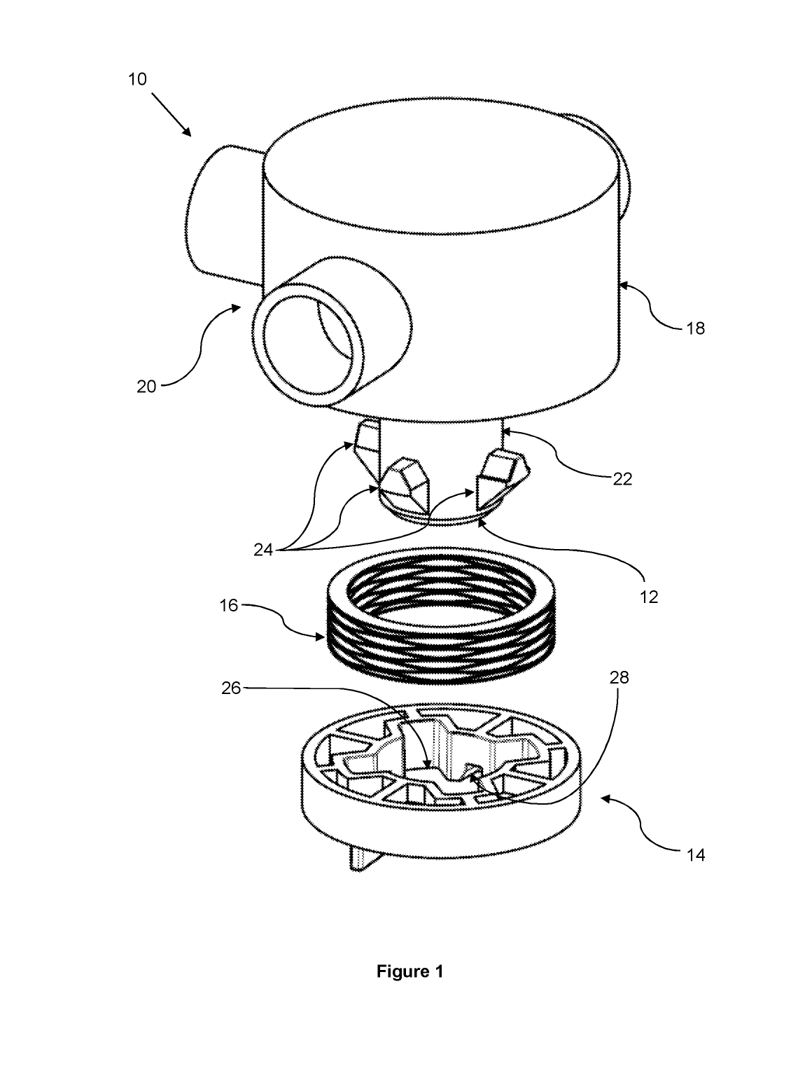

Referring to FIGS. 1 to 6, there is indicated a mounting system for vehicular components, referenced globally at 10. The mounting system 10 comprises a male connector 12, a female connector 14, and a vibration damping member 16. In the depicted embodiment, the male connector 12 is integrally formed with a module housing 18 of a first vehicular component 20, here depicted as a valve module, for example via vacuum moulding or metal casting. In most applications, it is anticipated that the module housing 18 will be formed from a plastics material.

The male connector 12 has a spigot 22 and a plurality of radial tabs 24 extending from the spigot 22. The radial tabs 24 are uniformly distributed around a circumference of the spigot 22 to evenly distribute forces thereon and reduce the likelihood of a radial tab breaking off from the spigot 22 or being knocked out of engagement with the female connector 14.

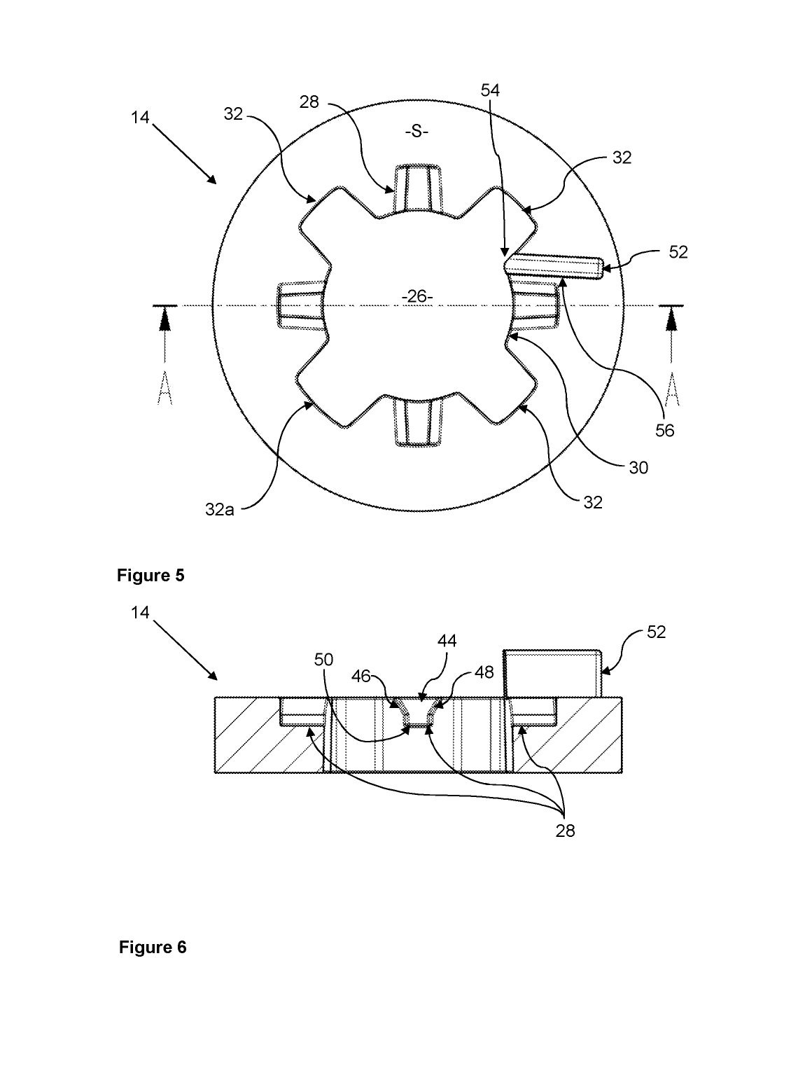

The female connector 14, shown best in FIGS. 5 and 6, comprises a primary receiver 26 and a plurality of secondary receivers 28. The primary receiver 26 is dimensioned such that the spigot 22 can be inserted therethrough, having a central aperture 30 with a plurality of radial notches 32 dimensioned to receive the radial tabs 24. A number of radial notches 32 may preferably correspond to the number of radial tabs 24. In the depicted embodiment, the primary receiver 26 has a circular central aperture 30, and four radial notches 32, corresponding with the four radial tabs 24. As such, the primary receiver 26 has a largely cruciform shape.

The secondary receivers 28 are positioned on a contact surface S of the female connector 14, and are dimensioned and shaped so as to receive the respective radial tabs 24 therein when the mounting system 10 is in a locked state.

The vibration damping member 16 is here provided as a wave spring, which is a spring comprising multiple turns of flat wire with waves added during the manufacturing process. A wave spring takes up less space than a traditional coiled spring with the same parameters, and the number of turns or waves may be adjusted to meet specific requirements for force or space. Other springs may be considered, as may other vibrationally damping components such as resilient components. The vibration damping member 16 provides vibration damping between the vehicular components, which can prevent damage to the sensitive components. This eliminates the need for separate shock absorbers, reducing the complexity of the mounting system 10 and easing installation.

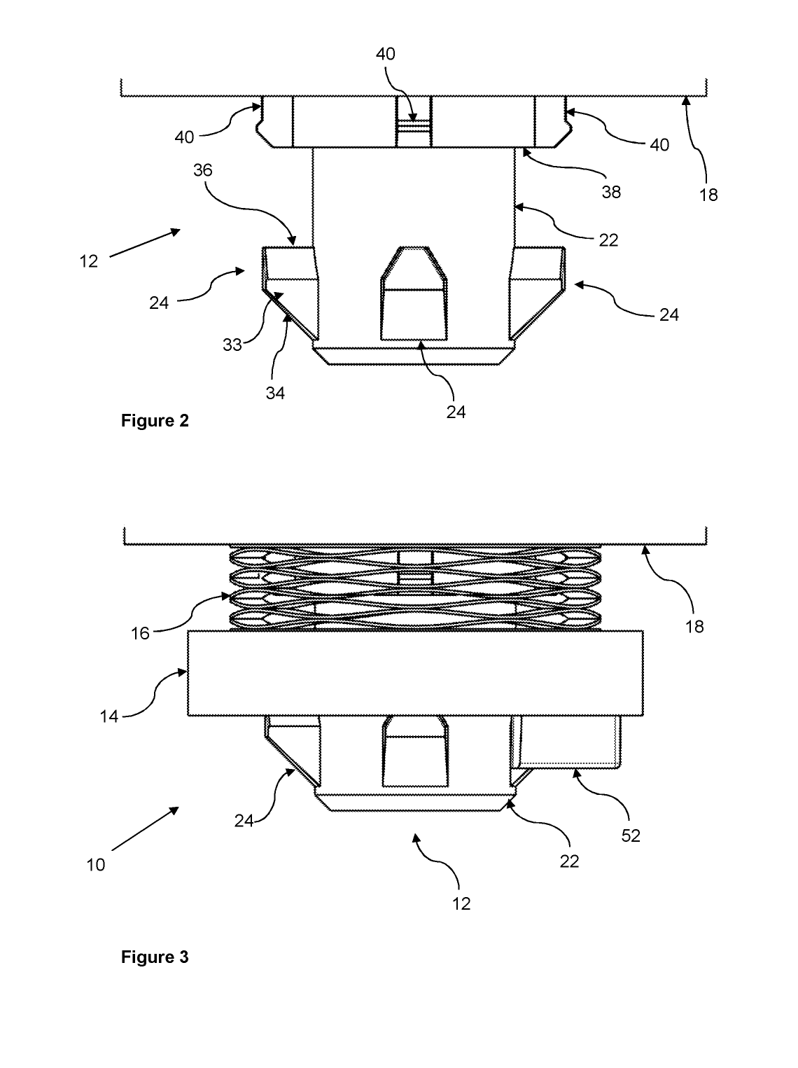

A side view of the male connector 12 in which the structure of the radial tabs 24 can be more clearly seen is shown in FIG. 2. Each of the radial tabs 24 has a radially extending body 33, having a sloped module-distal surface 34 which tapers outward from the spigot 22 in an axial direction, and a module-facing surface 36 which is designed to in-use contact the secondary receivers 28 of the female connector 14. In the depicted embodiment, the module-facing surface 36 has a trapezoidal cross-section in an axial tangent plane to the spigot 22.

The male connector 12 further comprises a buttress portion 38 at a module-proximal end of the spigot 22, which provides support to the spigot 22 and helps to prevent the male connector 12 from shearing from the module housing 18 of the first vehicular component 20 when subject to stresses and strains while the vehicle is in use. It is envisioned that the buttress portion 38 of the male connector 12 may additionally have a plurality of radially extending flanges uniformly spaced around the circumference of the spigot 22 for further support. The shape of the buttress portion 38 is designed to strengthen the portion between the module housing 18 and the spigot 22, and the illustrated shape is not intended to be limiting to possible design options.

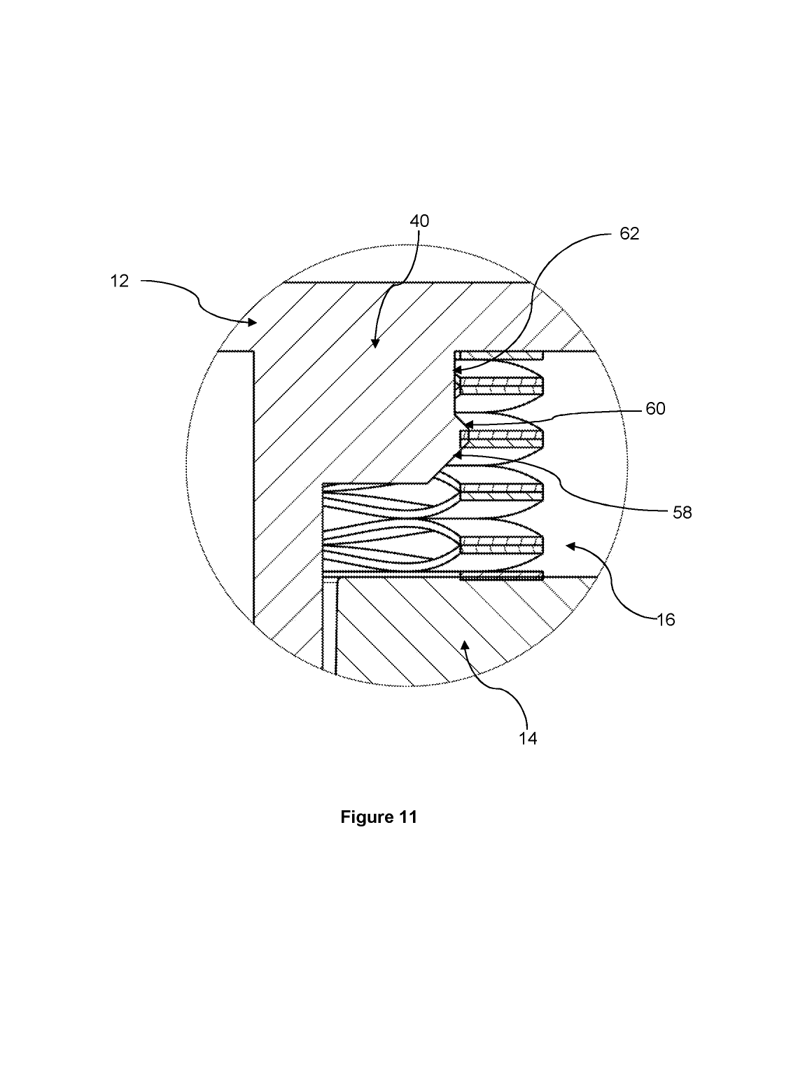

The male connector 12 additionally comprises a plurality of vibration-damping-member guide elements 40 to correctly align the vibration damping member 16 with the male connector 12. Here, these are shown as radial protrusions extending from the buttress portion 38. However, it will be appreciated that the vibration-damping-member guide elements 40 may also function as, or as part of, the buttress portion 38. The vibration-damping-member guide elements 40 abut the module housing 18 of the first vehicular component 20, providing further structural support for the spigot 22. This will be described in more detail in the discussion of FIGS. 10 and 11 below.

The mounting system 10 is shown in a locked state in FIG. 3, achieved by insertion of the male connector 12 into the primary receiver 26 and subsequent rotation of the male connector 12 relative to the female connector 14 until the radial tabs 24 are received by the secondary receivers 28. In the depicted embodiment, the locking of the mounting system 10 is facilitated by the vibration damping member 16, which is compressed as the male connector 12 is inserted into the primary receiver 26. The compressed vibration damping member 16 imparts a securing force which pushes the radial tabs 24 into the secondary receivers 28 after the male connector 12 is rotated to lock the mounting system 10. Should the vibration damping member 16 be provided in an alternative form to a wave spring, for instance as a rubber pad, locking may be aided by other means such as for example a magnetic lock mechanism with magnets included in the radial tabs 24 and/or secondary receivers 28, or via a latch or detent mechanism.

The male connector 12 may be disconnected from the female connector 14 by pushing against the vibration damping member 16 to lift the radial tabs 24 from the secondary receivers 28, rotating the male connector 12 relative to the female connector 14 to align the male connector 12 with the primary receiver 26, and then removing the male connector 12 from the female connector 14. The mounting system 10 being disengageable in this manner allows for the vehicular components to be detached from one another in the event that one or both of the parts needs to be replaced or repaired.

The twist-lock arrangement of the mounting system 10 allows for vehicular components to be easily and quickly mounted by hand, and the lack of bolts or screws means that no tools are required. Similarly, the two vehicular components can also be easily disconnected by hand, without the need for tools.

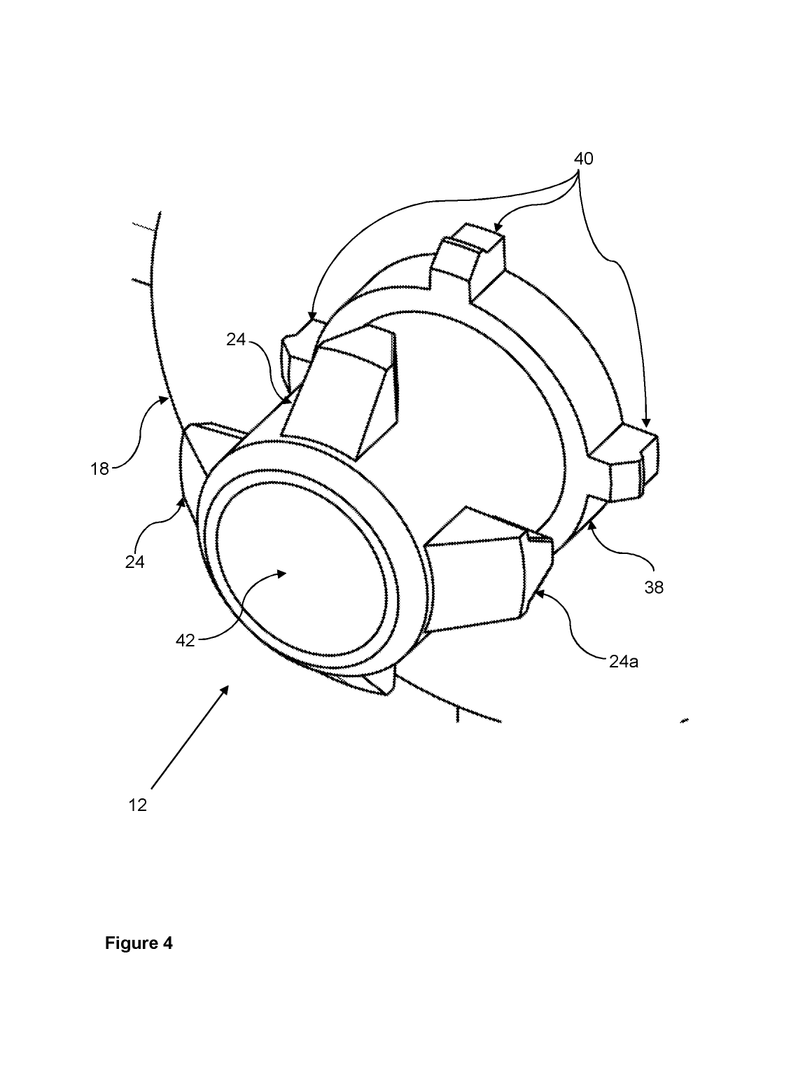

The male connector 12 is shown in detail in FIG. 4. As can be seen, the spigot 22 of the male connector 12 is hollow with a central bore 42 therethrough to reduce the weight and material cost of the mounting system 10. In alternative embodiments, the spigot 22 may instead be partially hollow with an internal support webbing, or may be entirely solid, for greater structural integrity.

The radial tabs 24 have identical module-facing surfaces 36 to one another, with the secondary receivers 28 being similarly identical, such that forces are evenly distributed with no specific points of wear. One of the plurality of radial tabs 24 has a larger module-distal surface than the other radial tabs 24, spanning a greater proportion of the circumference of the spigot 22.

Accordingly, one of the radial notches 32 of the female connector 14 is larger than the other radial notches 32, corresponding to the wider radial tab. This is best seen in FIG. 5, which shows the female connector 14 in more detail. The larger radial tab 24a and larger radial notch 32a acts as a poka-yoke mechanism, ensuring that the vehicular components are correctly orientated relative to one another when mounted by only allowing insertion of the male connector 12 through the primary receiver 26 for one orientation of the male connector 12 relative to the female connector 14.

Evidently, this poka-yoke mechanism could be accomplished by other means, typically by introducing a rotational asymmetry into the design . For example, one or more of the radial tabs 24 and corresponding radial notches 32 may be smaller or differently shaped to the other radial tabs 24 and notches, or the radial tabs 24, radial notches 32 and secondary receivers 28 may be asymmetrically distributed around the respective male and female connectors 12, 14.

FIG. 6 shows a cross sectional view across line A-A of FIG. 5, in which the structure of the secondary receivers 28 can be more clearly seen. The secondary receivers 28 of the female connector 14 are complementarily-shaped to the radial tabs 24. Here, each of the secondary receivers 28 has a tapered portion 44 corresponding to the shape of the module-facing surface 36 of each of the radial tabs 24. This tapered portion 44 allows for easier engagement of the respective radial tabs 24 with the secondary receivers 28, as the secondary receivers 28 are widest at the top and slope inwardly, helping to guide the radial tabs 24 into position. This makes engagement of the radial tabs 24 with the secondary receivers 28 easier, and reduces the risk of the user rotating the radial tabs 24 past the secondary receivers 28 without engagement unless an axial force is applied against the vibration damping member 16.

Each of the secondary receivers 28 has a first side wall 46 and a second side wall 48 opposed to the first side wall 46, with the two side walls 46, 48 being at a sufficiently steep angle relative to the contact surface S of the female connector 14 to inhibit rotation of the male connector 12 relative to the female connector 14 when the mounting system 10 is locked. In a preferred embodiment of the mounting system 10, the side walls 46, 48 are each at an angle between 30 and 90 degrees to the plane of the female connector 14. Most preferably, the side walls 46, 48 of the secondary receivers 28 are each at or substantially at an angle of 60 degrees to the plane of the female connector 14.

Each of secondary receivers 28 has a tolerance portion 50, which accommodates a portion of the respective module facing surface of the radial tabs 24. The secondary receivers 28 including the tolerance portion 50 are provided larger than the intended size of the radial tabs 24. This provides improved tolerances for the shape and size of the radial tabs 24 and secondary receivers 28, allowing tight engagement even if one or more of the radial tabs 24 is misshapen or incorrectly sized relative to the respective secondary receivers 28. This additionally extends the lifespan of the mounting system 10, as firm locking of the mounting system 10 is achieved even should the side walls 46, 48 of the secondary receivers 28 or the module-facing surface 36 deform due to wear.

There is an inter-tab stop 52 positioned on the contact surface S of the female connector 14 which projects proud of the contact surface S so as to be contactable with radial tabs 24 in use. The inter-tab stop 52 is here provided as a rectilinear protrusion, extending towards an edge of the contact surface S in a non-radial direction.

The inter-tab stop 52 further acts as a poka-yoke mechanism, preventing incorrect rotation of the male connector 12 relative to the female connector 14. In use, the inter-tab stop 52 is positioned between two of the plurality of radial tabs 24 after the male connector 12 is inserted through the primary receiver 26, with the inter-tab stop 52 bounded at one end by the primary receiver 26.

An edge 54 of the inter-tab stop 52 will be positioned adjacent to one of the radial tabs 24 immediately after insertion. This will prevent subsequent rotation in an incorrect direction; clockwise rotation would be inhibited were a male connector 12 inserted into the female connector 14 shown in FIG. 5.

The male connector 12 can be rotated in a correct direction, here anti-clockwise, u until a radial tab 24 would come into contact with a planar side 56 of the inter-tab stop 52, preventing the male connector 12 from being rotated too far and passing over the secondary receivers 28. To this end, the inter-tab stop 52 is positioned adjacent to and substantially parallel to an edge of one of the secondary receivers 28, such that the position the male connector 12 is stopped in by the inter-tab stop 52 when rotated in the correct direction is aligned with the secondary receivers 28. A plurality of inter-tab stops 52 could be provided, but the stop effect is achievable with a single inter-tab stop 52.

The contact surface S of the female connector 14 is flat or substantially flat and is preferably smooth or substantially smooth, for ease of rotation of the male connector 12 relative to the female connector 14 while the radial tabs 24 are in contact with the contact surface S.

It is anticipated that the female connector 14 may be integrally formed with a second vehicular component (not shown), or be fixedly or releasably engaged with the second vehicular component, to allow for the mounting of the first vehicular component 20 to the second vehicular component. The second vehicular component may be, for a non-exhaustive list of examples, a fan shroud or a vehicle chassis. Alternatively, the female connector 14 may be provided as a separate component, to help retain the vibration damping member 16 for transportation or storage.

The mounting system 10 can thus be operated quickly and simply while being resistant to user error, as the user can simply insert the male connector 12 into the female connector 14, rotate the male connector 12 in the correct direction until a radial tab comes into contact with the inter-tab stop 52, then engage the radial tabs 24 with the secondary receivers 28 to lock the mounting system 10. Beneficially, this allows the user to mount the first vehicular component 20 to the second vehicular component or vice versa without the need for any tools, such as a screwdriver, riveter, or welding equipment.

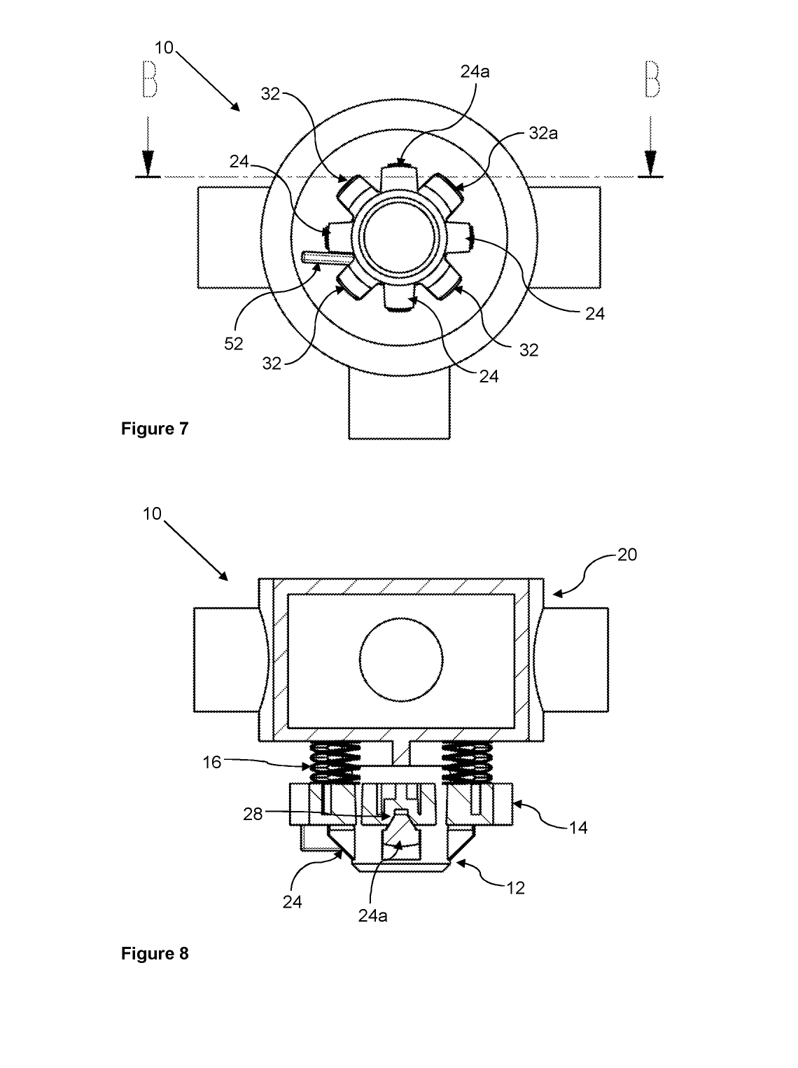

FIGS. 7 and 9 show a plan view of the mounting system 10 in the locked position, where the plurality of radial tabs 24 is engaged with the plurality of secondary receivers 28.

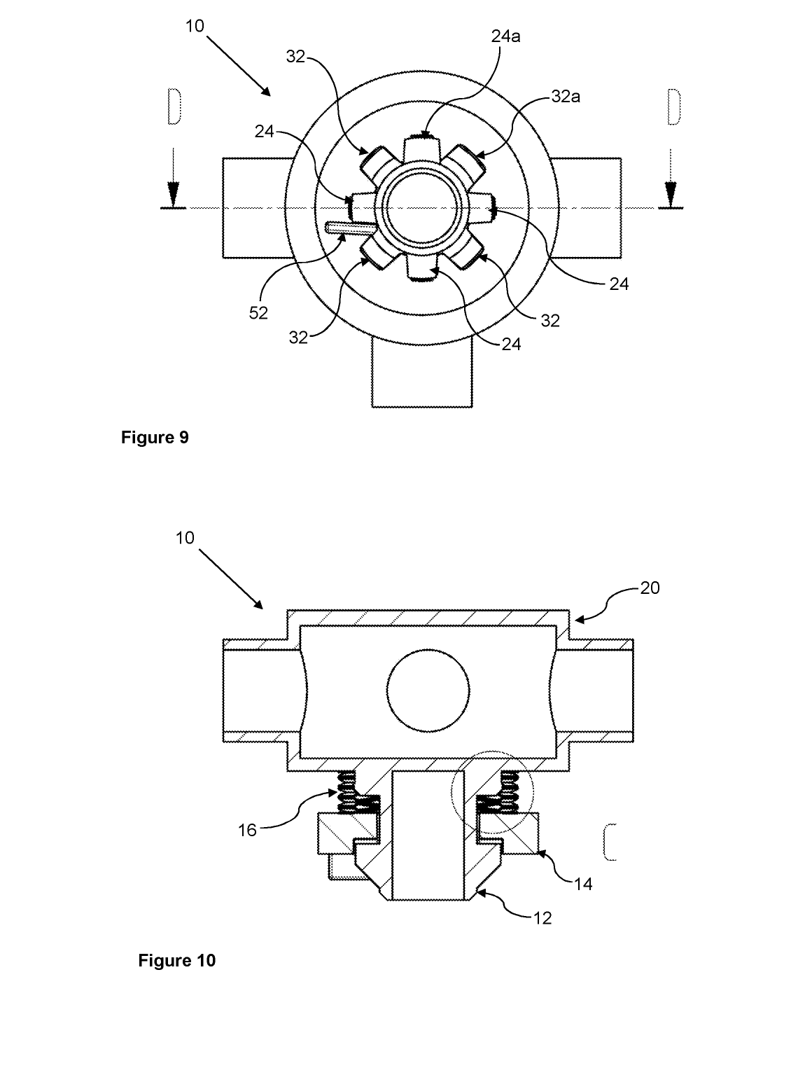

The cross section across line B-B is shown in FIG. 8, showing the mounting system 10 in the locked state, with the radial tabs 24 engaged with the secondary receivers 28 and the vibration damping member 16 in abutment engagement with the female connector 14. An abutment surface of the female connector 14 is flat or substantially flat for ease of abutment engagement with the vibration damping member 16, maximising the vibration damping between the first vehicular component 20 and second vehicular component.

FIGS. 10 and 11 show how the vibration dampening member is aligned and retained by the vibration-damping-member guide elements 40 of the male connector 12. The vibration-damping-member guide elements 40 each have a retaining element 58 which engages with the vibration-damping member to prevent axial displacement of the vibration damping member 16 relative to the male connector 12.

The retaining element 58 is provided as a curved lip 60 positioned at a module-distal end of the vibration-damping-member guide elements 40, which extends proud of an outer wall 62 thereof. The vibration dampening member 16 is then receivable onto the male connector 12, with the vibration-damping-member guide elements 40 being distributed around the circumference of the spigot 22 of the male connector 12, collectively defining a diameter equal to an inner diameter of the vibration dampening member 16, such that the vibration dampening member 16 is insertable onto the vibration-damping-member guide elements 40 and thereby aligned with the male connector 12.

Here, engagement is achieved via one or more coils of the wave spring forming the vibration damping member 16 being insertable over the retaining element 58. The slope and/or rounding of the curved lip 60 of the retaining element 58 makes it easy to pass coils over the retaining element 58 on to the vibration-damping-member guide elements 40, but biases against removing the coils from the vibration-damping-member guide elements 40 to detach the spring, thus allowing the spring to be retained by the male connector 12. The number of coils which are passed over the retaining element 58 may be decided based on the required need for spring retention based on the expected forces the vehicular mounting system 10 will be subject to, or to change the tension in the spring.

In the case of the female connector 14 being provided as a separate component not integrally formed or fixedly engaged with the second vehicular component, the male connector 12 may be engaged with the female connector 14 to further retain the vibration damping member 16, for transportation or storage.

The vibration damping member 16 can thus be installed onto the male connector 12 ahead of time, making transport of the vehicular components and mounting system 10 easier, reducing the risk of losing components, and simplifying the installation process.

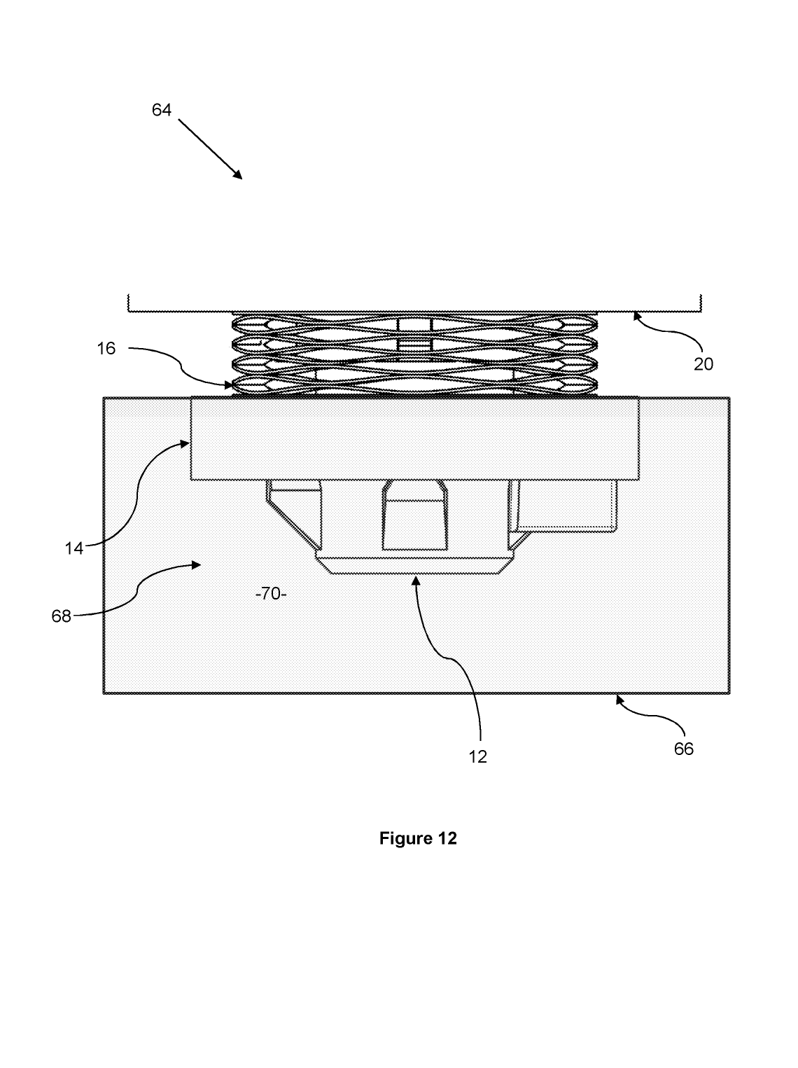

Shown in FIG. 12 is a vehicular component assembly 64, the vehicular component assembly 60 comprising a first vehicular component 20 and a second vehicular component 66, the first and second vehicular components 20, 66 being mounted to one another via the mounting system 10 as discussed above. Identical or similar reference numerals will be used to refer to identical or similar components, and further detailed description is omitted for brevity.

The female connector 14 is here integrally formed with the second vehicular component 66, shown in a transparent form to indicate where the parts of the mounting system 10 are located. The connector body 68 of the female connector 14 thus defines an internal chamber 70 into which a head of the male connector 12 is receivable

The female connector 14 may be integrally formed with the second vehicular component 66 via, for example, vacuum moulding or metal casting. In the case of the female connector 14 being integrally formed with the second vehicular component 66, the male connector 12 may be integrally formed with the first vehicular component 20, or may alternatively be fixedly or releasably engaged with the first vehicular component 20.

In the depictions shown and described above, the first vehicular component is a valve module, but the first vehicular component may be any component of a vehicle, such as a fan module or a pump module, to provide a non-exhaustive list of examples.

While the embodiments of the vehicle mounting system described above have four radial tabs and four secondary receivers, it is appreciated that any number of radial tabs may be provided, with a complementary number of secondary receivers.

The present invention therefore provides a mounting system which allows for vehicular components to be quickly and easily mounted while being robust to vibrations encountered during operation of a vehicle, and which is simpler and cheaper to manufacture and supply due to comprising fewer components than existing mounting systems.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

Although certain inventive embodiments of the present disclosure have been specifically described, the present disclosure is not to be construed as being limited thereto. Various changes or modifications may be made to the present disclosure without departing from the scope and spirit of the present disclosure.

1. A mounting system for vehicular components, the mounting system comprising:
a male connector having a spigot and a plurality of radial tabs extending from the spigot;
a female connector having a primary receiver for receiving the spigot of the male connector and a plurality of secondary receivers for receiving the plurality of radial tabs in a twist-lock arrangement; and
characterised in that the male connector or the female connector is integrally formed with a module housing of a first vehicular component, and the other of the male connector and female connector is associated with a second vehicular component to permit interconnection of the first and second vehicular components via the mounting system, and
further comprising a vibration damping member receivable around the spigot so as to be in abutment engagement with the female connector when connected to the male connector and provide vibrational damping therebetween.

2. The mounting system as claimed in claim 1, wherein the male connector is integrally formed with the said module housing of the said first vehicular component.

3. The mounting system as claimed in claim 1, wherein the female connector is provided as an adapter receivably engagable with the said second vehicular component.

4. The mounting system as claimed in claim 1, wherein the female connector is integrally formed with a module housing of the second vehicular component.

5. The mounting system as claimed in claim 1, wherein the female connector comprises a connector body defining an internal chamber into which a head of the male connector is receivable.

6. The mounting system as claimed in claim 1, wherein each of the plurality of radial tabs has a module-facing surface engagable with the respective plurality of secondary receivers of the female connector.

7. The mounting system as claimed in claim 6, wherein the module-facing surface has a tapered or angled cross-section.

8. The mounting system as claimed in claim 7, wherein the plurality of secondary receivers each have complementary shapes to the module-facing surfaces.

9. The mounting system as claimed in claim 6, wherein one of the plurality of radial tabs has a different shape or size to the other of the plurality of radial tabs.

10. The mounting system as claimed in claim 1, wherein the male connector comprises a buttress portion at a module-proximal end of the spigot.

11. The mounting system as claimed in claim 1, wherein the male connector comprises a vibration-damping-member guide element associated with the spigot for aligning the vibration damping member.

12. The mounting system as claimed in claim 11, wherein the vibration-damping-member guide element comprises a retaining element engagable with the vibration damping member to inhibit axial displacement thereof relative to the male connector.

13. The mounting system as claimed in claim 11, wherein the vibration damping member is formed as a spring.

14. The mounting system as claimed in claim 13, wherein the spring is a wave spring.

15. The mounting system as claimed in claim 1, wherein the female connector comprises an inter-tab stop in-use positioned between adjacent tabs of the plurality of radial tabs to inhibit an incorrect relative rotation between the male connector and the female connector.

16. A vehicular component assembly comprising a first vehicular component and a second vehicular component to be mounted to one another as part of a vehicle, the first and second vehicular components being mounted to one another via a mounting system as claimed in claim 1.

17. The vehicular component assembly as claimed in claim 16, wherein the first vehicular component is a valve module, a pump module, or a fan module.

18. A vehicle comprising a vehicular component assembly as claimed in claim 16.

19. A vehicular component comprising:
a module housing; and
a male connector having a spigot and a plurality of radial tabs extending from the spigot, the male connector being suitable for twist-lock engagement with a female connector having a primary receiver for receiving the spigot of the male connector and a plurality of secondary receivers for receiving the plurality of radial tabs; and
characterised in that the male connector is integrally formed with the module housing.

20. The vehicular component as claimed in claim 19, further comprising a vibration damping member receivable around the spigot so as to be in abutment engagement with the said female connector when connected to the male connector and provide vibrational damping therebetween.
